(19) United States
(12) Patent Application Publication
(10) Pub. No.: US 2012/0200527 A1
(43) Pub. Date: Aug. 9, 2012

(54) CAPACITIVE TOUCH PANELS

(76) Inventor: Philip Thomas Rumsby, Oxon (GB)

(21) Appl. No.: 13/389,836

(22) PCT Filed: Sep. 29, 2009
(86) PCT No.: PCT/GB2009/002294

§ 371 Date: Mar. 15, 2012

(30) Foreign Application Priority Data
Aug. 11, 2009 (GB) 0914076.5

(51) Int. Cl. G06F 3/044

(52) U.S. Cl. 345/174

(57) ABSTRACT

A capacitive touch panel comprising; a transparent substrate, a layer of transparent conducting material (71) deposited onto a surface of the transparent substrate, the layer of transparent conducting material (71) being divided to form a plurality of discrete electrode cells which are electrically connected in a first orthogonal direction X but electrically isolated in a second orthogonal direction Y, a deposited pattern of transparent insulating material (73) on the transparent conducting layer (71), the pattern configured to bridge adjacent electrically isolated cells, and a deposited pattern of transparent conducting material (74) overlaying and intersecting with the deposited pattern of transparent insulating material (73) thereby providing an electrical connection between adjacent electrically isolated cells and thereby providing two orthogonal conduction paths across the transparent conducting layer (71).

The present invention relates to improvements in capacitive touch panels, in particular, the invention relates to transparent bridge interconnect structures for use in capacitive touch panels and a method for providing such interconnect structures.

Capacitive touch panel technology is in wide use, for example in mobile phones, satellite navigation systems, PDA screens and handheld games consoles.

One particular form of capacitive touch panel is known as projective capacitive touch technology or “PCT”. In PCT devices, an XY array of sensing electrodes is formed in layers of transparent conducting material. In use, capacitance forms between the user's fingers and the projected capacitance from the sensing electrodes. A touch is made, precisely measured and translated into a command which is executed by underlying electronic devices for an appropriate software application. PCT screens enjoy the benefits of responding accurately to both fingers and styli.

One particular form of PCT technology uses a single layer of transparent conducting material and it is the changes in the self-capacitance between separate areas in this layer that are detected. A convenient way to make such a single layer PCT device is to divide up the conducting layer into electrically separated areas that are then interconnected to form sets of orthogonal electrodes. Since the interconnections have to be conducting it is usual to form these with structures based on fine lines of metallic material. Whilst they do not obstruct viewing of the images, present metallic material based interconnect technologies reflect light and so are visible on close inspection of the screen and so the image quality as viewed by the user is impaired.

In addition use of metallic material for these interconnects generally requires a complex multi stage manufacturing process involving metal deposition, resist coating, masking, exposing, resist developing, etching and resist stripping. Such processes use many chemicals and consume much energy and hence are costly.

The present invention seeks to provide an alternative construction for a PCT panel which provides for improved image viewing and other advantages over the prior art

In accordance with the present invention there is provided a method for providing a transparent bridge interconnect structure in a capacitive touch panel comprising;

onto a transparent conducting layer deposited on a transparent substrate and divided into a plurality of discrete electrode cells which are electrically connected in a first direction but electrically isolated in a second direction;

1. depositing a pattern of transparent insulating material, the pattern configured to bridge adjacent electrically isolated electrode cells, and
2. depositing a pattern of transparent conducting material configured to overlay and intersect with the deposited pattern of transparent insulating material thereby to provide an electrical connection between the electrically isolated cells,
whereby to provide two conduction paths across the transparent conducting layer.

Typically, the two directions are orthogonal to one another.

Conveniently, step 1 and/or 2 is achieved using an inkjet printing technique.

Optionally, either or both of the deposits in steps 1 and 2 may comprise a series of uniformly spaced continuous lines.

In another aspect, the invention comprises a capacitive touch panel comprising;

a transparent substrate, a layer of transparent conducting material deposited onto a surface of the transparent substrate, the layer of transparent conducting material being divided to form a plurality of discrete electrode cells which are electrically connected in a first direction but electrically isolated in a second direction, a deposited pattern of transparent insulating material on the transparent conducting layer, the pattern configured to bridge adjacent electrically isolated cells, and a deposited pattern of transparent conducting material overlaying and intersecting with the deposited pattern of transparent insulating material thereby providing an electrical connection between adjacent electrically isolated cells and thereby providing two conduction paths across the transparent conducting layer.

Typically, the two directions are orthogonal to one another.

The electrode cells are each similarly shaped and sized and arranged in interleaved columns, though are not restricted to one shape. For example but without limitation, the cells may be square, diamond, lozenge or tear drop shaped.

The electrode cells may conveniently be defined using laser scribing techniques. Scribed lines may be sharp angled or curved to produce differently shaped electrode cells.

The base transparent electrically conducting layer may, for example, comprise indium tin oxide. Other suitable transparent conducting oxides include, without limitation, Tin oxide (SnO2), doped Zinc oxide (ZnO), etc. This layer may also be of organic conducting material. Examples of organic materials (without limitation) are PEDOT (polyethylenedioxythiophene), polyanilene or polythiophene. Such polymers are selected to achieve coatings with the required optical transmittance (desirably 90% in range 400-800nm) and surface resistance of typically less than 100 or 200 Ω per square. Soluble conducting polymers based on polyanilines, polythiophenes, polypyrroles or polyisothianaphthenes meet these requirements. These same inorganic and organic conducting materials can also be used for the conducting material applied by ink jet techniques. The transparent insulating material applied by ink jet techniques may also be of organic or inorganic type. Examples of inorganic insulating materials include (without limitation) silicon dioxide, glass and silicon nitride. Examples of organic insulating materials include (without limitation) PVP (polyvinylphenol), PVP PMMA (polyvinylphenol-co-methyl-methacrylate), PMMA (polymethyl methacrylate) and PVDF (polyvinylidene fluoride). Such polymers are selected to achieve a required transmittance of 90% in range 400-800 nm and surface resistance exceeding about 1 GΩ per square.

Optionally, either or both of the deposits of electrically conductive and electrically insulating material comprise a series of uniformly spaced continuous lines.

The transparent substrate may be organic (plastic) or inorganic (glass).

In another aspect, the invention provides an apparatus for providing a transparent bridge interconnect structure in a capacitive touch panel in accordance with the method as hereinabove described, the apparatus comprising; a laser, an ink jet printing head, means for holding a transparent conducting layer deposited on a transparent substrate, means for adjusting the relative positions of the laser and ink jet print head to the transparent conducting layer and a controller to control the laser and ink jet print head whereby in a first step to divide, by means of a laser cutting technique, the transparent conducting layer to form a plurality of discrete electrode cells which are electrically connected in a first direction but electrically isolated in a second direction and in a second step to deposit, by means of an inkjet printing process, a pattern of transparent insulating material, the pattern configured to bridge adjacent electrically isolated electrode cells.

Optionally, the controller is further configured in a third step to deposit, by means of an inkjet printing process, a pattern of transparent conducting material configured to overlay and intersect with the deposited pattern of transparent insulating material thereby to provide an electrical connection between the electrically isolated cells.

In order to better explain the invention, examples of the known prior art and the applicant's invention will now be further described with reference to the accompanying drawings in which;

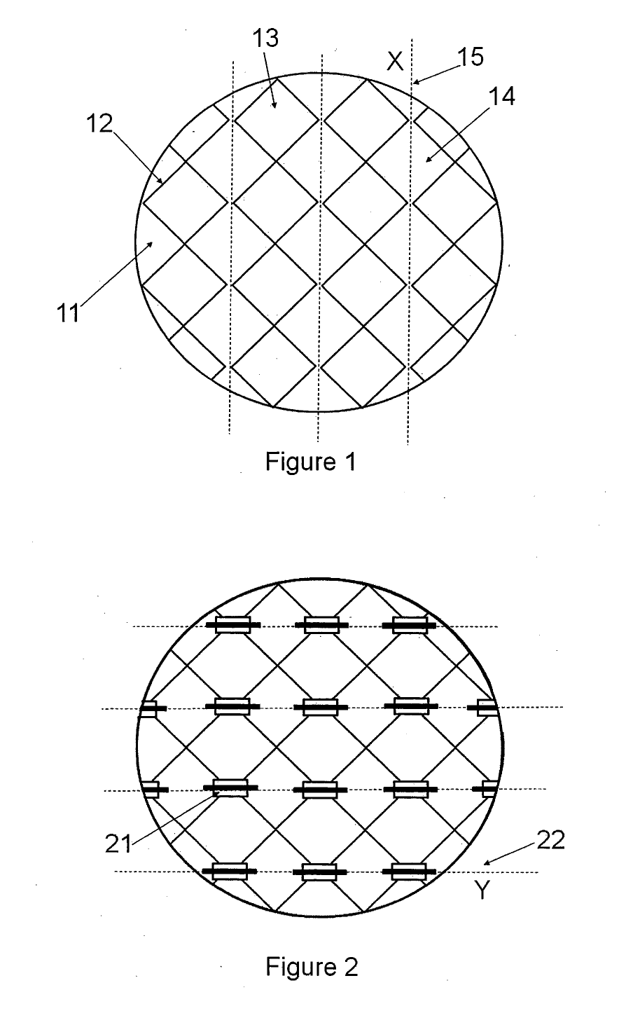

FIG. 1 shows a prior art single layer capacitive touch panel in a first step of its construction;

FIG. 2 shows the prior art panel of FIG. 1 in a second step of its construction;

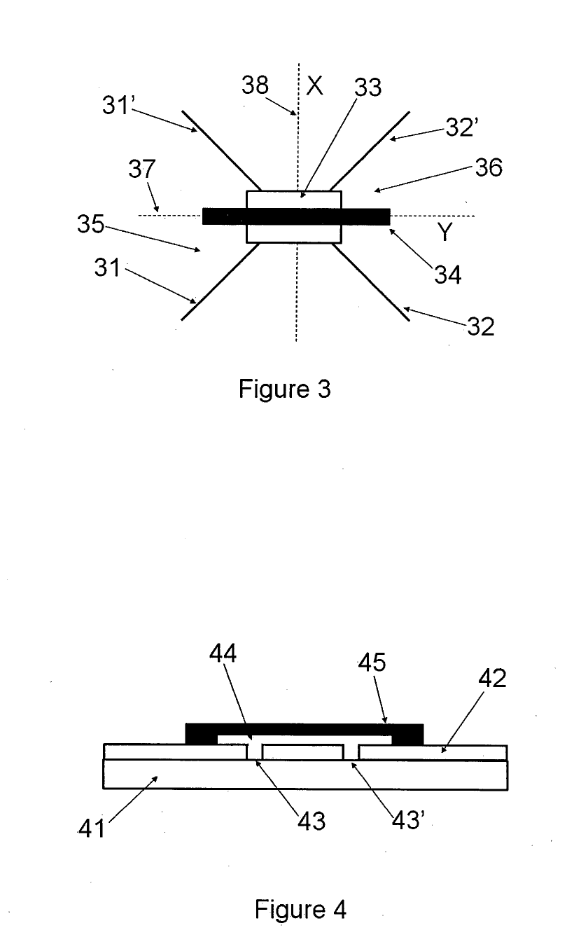

FIG. 3 shows a top view of one of the conductive bridge devices of a prior art capacitive touch panel resulting from the first and second processes illustrated in FIGS. 1 and 2;

FIG. 4 shows a side view of the structure of FIG. 3;

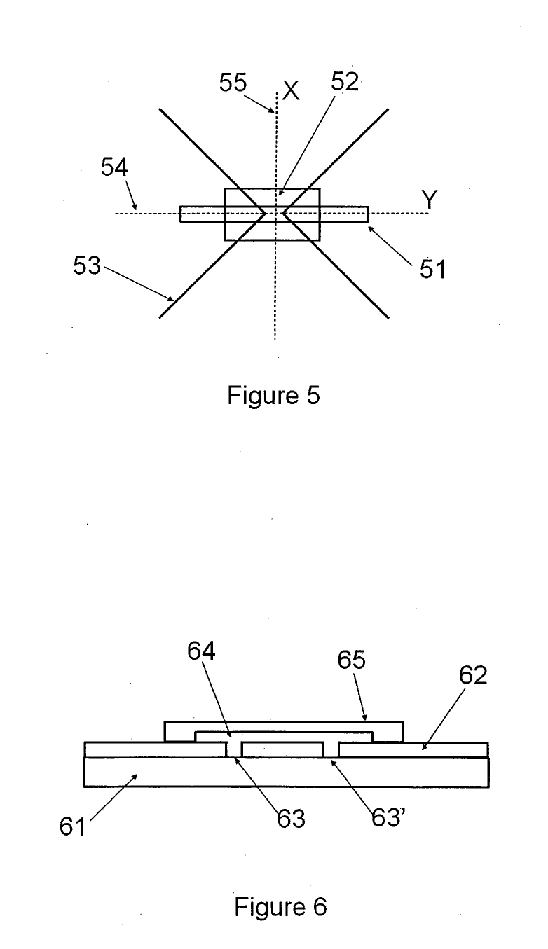

FIG. 5 shows constructions of a transparent bridge interconnecting structure in a capacitive touch screen device in accordance with the present invention;

FIG. 6 shows a side view of the bridge structure of FIG. 5;

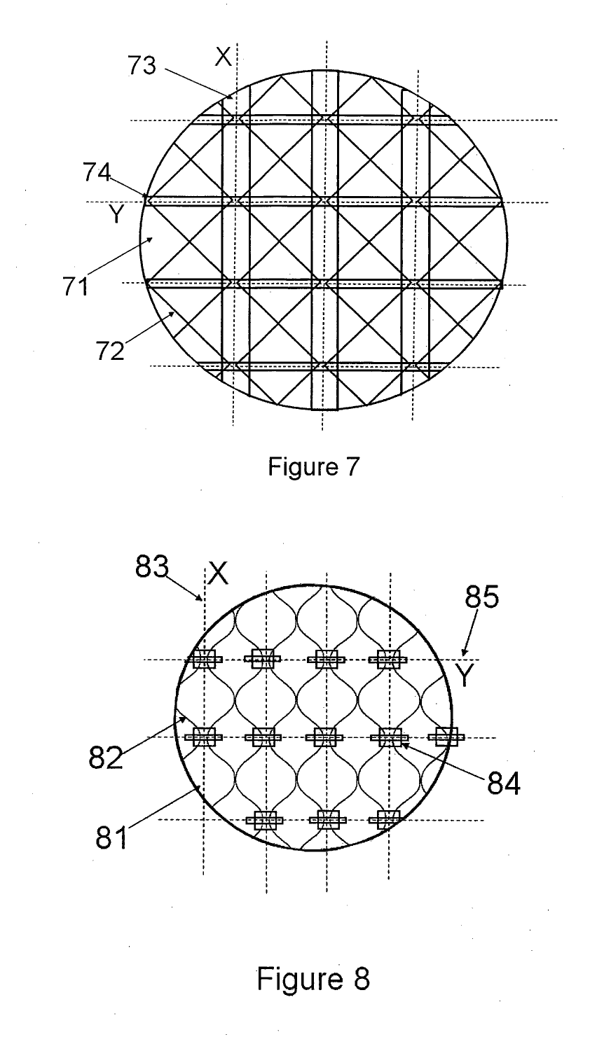

FIGS. 7 and 8 show some alternative geometries for the novel bridge structure illustrated in FIGS. 5 and 6.

FIG. 1 (Prior Art) shows a section of a typical electrode pattern for a single layer capacitive touch panel in its first stage of manufacture. A thin layer 11 of transparent conducting material is deposited uniformly on top of a transparent substrate. A lithographic process is then generally used to remove lines of material 12 to divide up the conducting layer and to form columns of electrically isolated squares 13 and columns of electrically connected squares 14. The connected squares 14 of conducting material 11 give rise to columns of continuously conducting electrodes 15 parallel to a first (X) direction along the full length of the touch panel. Lasers are also used to pattern the conducting layer.

FIG. 2 (Prior Art) shows how the electrically isolated squares 13 are joined by means of conducting metallic bridge structures 21 to form continuously conducting rows of electrodes 22 in a second (Y) direction.

FIG. 3 (Prior Art) shows a detailed top view of one of the conducting bridge structures 21. Lines 31, 31′ and 32, 32′ are in the conducting layer and separate it electrically as shown in FIG. 1. A patch of insulating material 33 has on top of it a line of conducting metallic material 34 which bridges across from isolated square 35 to isolated square 36. Such insulating patches 33 and conducting lines are generally formed by lithographic processes. By repeating this two layer bridge device at all equivalent points on the touch panel, rows 37 of conducting electrodes are formed in the Y direction intersecting with the columns of conducting electrodes 38 in the X direction.

FIG. 4 (Prior Art) shows a side view of a bridge structure as illustrated in FIG. 3. A transparent substrate of plastic or glass 41 has deposited on it a thin layer of transparent conducting material 42. This is typically an inorganic material such as ITO (Indium Tin Oxide). 43 and 43′ are lines formed in the conducting layer 42 by lithography or lasers which serve to separate it into the structure show in FIG. 1. A patch of insulating material 44 extends across both cuts in the conducting layer 42. This material may be organic or inorganic. A line of metallic conducting material 45 forms the conducting path from one side of the cuts to the other. This line 45 is generally made by lithography as it has to be very fine so that it cannot be seen.

FIG. 5 shows a first embodiment of the novel construction of the present invention. A transparent conducting line of material 51 replaces the opaque metal line 45 described in relation to the prior art device of FIG. 4. The transparent conducting material 51 is deposited by ink jet printing techniques and because it is transparent does not have to be narrow to remain unseen. The line of transparent conducting material 51 is applied over a patch of insulating material 52 which is also transparent and is also applied by ink jet methods. The cuts 53 in the lower conducting layer are made by laser scribing. The whole bridge device allows a conduction path in the Y direction 54 by means of going “over” the bridge and a path in the X direction 55 by going “under” the bridge.

FIG. 6 shows a side view of a transparent bridge structure of FIG. 5. A transparent substrate of plastic or glass 61 has a thin layer of transparent conducting material 62 deposited onto it. This is for example an inorganic material such as ITO (Indium Tin Oxide). 63 and 63′ are the lines formed in the conducting layer by lasers to separate it into the structure already shown in FIG. 1. A patch of transparent insulating material 64 extends across both cuts in the conducting layer 62. This material may be organic or inorganic and is applied by ink jet printing methods. A line of transparent conducting material 65 forms the conducting path from one side of the cuts to the other. This material is applied by ink jet methods and as it is transparent it does not need to be very fine so that it cannot be seen. The whole bridge device allows 2 orthogonal conduction paths in one case by going “over” the bridge and in another case by going “under” the bridge.

FIG. 7 shows alternative bridge geometries applying similar construction principles to those shown in FIGS. 5 and 6. The areas of insulating and conducting transparent material at each bridge do not have to be localized patches as previously described. As the materials are transparent there is no need to make them small and they can be made bigger and even extended to form continuous bands. FIG. 7 shows a continuous transparent conducting layer 71 divided up into columns of electrically connected and electrically isolated squares by means of laser scribe lines 72. In this case however the discrete areas of transparent insulating film at each bridge are now replaced by continuous bands 73 extending over the full length of the columns and discrete areas of transparent conducting film at each bridge are replaced by continuous bands 74 extending over the full length of the rows. Columns of transparent insulating material and rows of transparent conducting material can both be made up of continuous bands as shown. Alternatively either one can be made up of discrete patches and the other as continuous bands.

FIG. 8 shows that electrode shapes do not have to square as shown in FIGS. 1 to 7. FIG. 8 shows one alternative shape where the continuous conducting film 81 is laser scribed with a wave shape 82 to form columns of electrically connected lozenges shapes 83 in the X direction. Columns of electrically isolated lozenge shapes are also formed in the X direction. These are connected by adding ink jet printed transparent bridges 84 to form rows of conducting material 85 in the Y direction. Many other laser scribe trajectories are possible giving rise to many possible electrode shapes. For example, but without limitation, diamond and elongated lozenge shapes are envisaged.

1. A method for providing a transparent bridge interconnecting structure in a capacitive touch panel comprising;
onto a transparent conducting layer deposited on a transparent substrate and divided into a plurality of discrete electrode cells which are electrically connected in a first direction but electrically isolated in a second direction;
1. depositing a pattern of transparent insulating material, the pattern configured to bridge adjacent electrically isolated electrode cells, and
2. depositing a pattern of transparent conducting material configured to overlay and intersect with the deposited pattern of transparent insulating material thereby to provide an electrical connection between the electrically isolated cells,
whereby to provide two conduction paths across the transparent conducting layer.

2. A method as claimed in claim 1 wherein the two conduction paths are orthogonal to one another.

3. A method as claimed in claim 1 or 2 wherein step 1 and/or 2 is achieved using an inkjet printing technique.

4. A method as claimed in claim 1, 2 or 3 wherein either or both of the deposits in steps 1 and 2 comprises a series of uniformly spaced continuous lines.

5. A method as claimed in any preceding claim wherein the transparent insulating material is a soluble insulating polymer selected from; PVP (polyvinylphenol), PVP PMMA (polyvinylphenol-co-methyl-methacrylate), PMMA (polymethyl methacrylate) and PVDF (polyvinylidene fluoride).

6. A method as claimed in any preceding claim wherein the transparent conducting material is a soluble conducting polymer selected from;
PEDOT (polyethylenedioxythiophene), polyanilene, polythiophene or is based on a polyaniline, a polythiophene, a polypyrrole or a polyisothianaphthene.

7. A capacitive touch panel comprising;
a transparent substrate, a layer of transparent conducting material deposited onto a surface of the transparent substrate, the layer of transparent conducting material being divided to form a plurality of discrete electrode cells which are electrically connected in a first direction but electrically isolated in a second direction, a deposited pattern of transparent insulating material on the transparent conducting layer, the pattern configured to bridge adjacent electrically isolated cells, and a deposited pattern of transparent conducting material overlaying and intersecting with the deposited pattern of transparent insulating material thereby providing an electrical connection between adjacent electrically isolated cells and thereby providing two conduction paths across the transparent conducting layer.

8. A capacitive touch panel as claimed in claim 7 wherein the first and second directions are orthogonal with one another and the two conduction paths are orthogonal with one another.

9. A capacitive touch panel as claimed in claim 7 or 8 wherein the electrode cells are each similarly shaped and sized and arranged in interleaved columns and the shape of the cells is selected from square, diamond, lozenge or tear drop shaped.

10. A capacitive touch panel as claimed in claim 7, 8 or 9 wherein the electrode cells are defined by laser scribed lines.

11. A capacitive touch panel as claimed in any of claims 7 to 10 wherein the transparent electrically conducting layer and/or the deposit of transparent electrically conducting material comprise indium tin oxide.

12. A capacitive touch panel as claimed in any of claims 7 to 11 wherein either or both of the deposits of electrically conductive and electrically insulating material comprise a series of uniformly spaced continuous lines.

13. A capacitive touch panel as claimed in any of claims 7 to 12 wherein the deposit of transparent electrically conducting material is a soluble conducting polymer selected from; PEDOT (polyethylenedioxythiophene), polyanilene, polythiophene or is based on a polyaniline, a polythiophene, a polypyrrole or a polyisothianaphthene.

14. A capacitive touch panel as claimed in any of claims 7 to 13 wherein the transparent insulating material is a soluble insulating polymer selected from; PVP (polyvinylphenol), PVP PMMA (polyvinylphenol-co-methyl-methacrylate), PMMA (polymethyl methacrylate) and PVDF (polyvinylidene fluoride).

15. A capacitive touch panel substantially as described herein and with reference to the accompanying FIGS. 5 to 8.

16. An apparatus for providing a transparent bridge interconnect structure in a capacitive touch panel in accordance with the method as hereinabove described, the apparatus comprising; a laser, an ink jet printing head, means for holding a transparent conducting layer deposited on a transparent substrate, means for adjusting the relative positions of the laser and ink jet print head to the transparent conducting layer and a controller to control the laser and ink jet print head whereby in a first step to divide, by means of a laser cutting technique, the transparent conducting layer to form a plurality of discrete electrode cells which are electrically connected in a first direction but electrically isolated in a second direction and in a second step to deposit, by means of an inkjet printing process, a pattern of transparent insulating material, the pattern configured to bridge adjacent electrically isolated electrode cells.

17. An apparatus as claimed in claim 16 wherein the controller is further configured in a third step to deposit, by means of an inkjet printing process, a pattern of transparent conducting material configured to overlay and intersect with the deposited pattern of transparent insulating material thereby to provide an electrical connection between the electrically isolated cells.
